(19) United States
(12) Patent Application Publication
(10) Pub. No.: US 2012/0001550 A1
(43) Pub. Date: Jan. 5, 2012

(54) MAGNETIC MODUE OF ELECTRON CYCLOTRON RESONANCE AND ELECTRON CYCLOTRON RESONANCE APPARATUS USING THE SAME

(75) Inventors: Chih-Chen Chang, Taipei County (TW); Kun-Ping Huang, Miaoli County (TW); Kang-Feng Lee, Taipei City (TW)

(73) Assignee: INDUSTRIAL TECHNOLOGY RESEARCH INSTITUTE, Hsinchu (TW)

(21) Appl. No.: 12/960,887

(22) Filed: Dec. 6, 2010

(30) Foreign Application Priority Data
Jul. 2, 2010 (TW) 099121856

(51) Int. Cl. H01J 7/00

(52) U.S. Cl. 315/111.41

(57) ABSTRACT

The present invention provides a magnetic module for electron cyclotron resonance (ECR) and ECR apparatus using the magnetic module, wherein the magnetic module comprises a plurality of layers of supporting ring and a plurality of magnetic pillars. Each of the supporting rings has an outer surface and an inner surface and has a plurality of through holes radially disposed inside the supporting ring. The plurality of pillars are respectively embedded into the plurality of through holes of each supporting ring and magnetic fields of the magnetic pillars in each two adjacent supporting ring are respectively opposite to each other. The ECR apparatus of the present invention is capable of being operated under lower pressure environment for forming a single atom layer on a substrate.

### CROSS-REFERENCE TO RELATED APPLICATIONS

This non-provisional application claims priority under 35 U.S.C. §119(a) on Patent Application No(s). 099121856 filed in Taiwan, R.O.C. on Jul. 2, 2010, the entire contents of which are hereby incorporated by reference.

### TECHNICAL FIELD

The present disclosure relates to a plasma generation technique, and more particularly, to a magnetic module for electron cyclotron resonance (ECR) and ECR apparatus using the same, capable of operating under lower pressure environment for generating high-density plasma.

### TECHNICAL BACKGROUND

As semiconductor components being made thinner, lighter and smaller, current chemical vapor (CVD) process is able to deposit a film of single atom layer. However, in order to obtain a satisfactory single atom layer, a high density plasma deposition equipment for performing under a low-pressure environment is required. Moreover, since conventionally the electron cyclotron resonance chemical vapor deposition (ECR-CVD) tool is configured as an electromagnetic system, it is a high current application that requires a great amount of cooling water for heat dissipation.

Please refer to FIG. 1, which is a schematic diagram showing a conventional Halbach-type magnetic pole. As shown in FIG. 1, a Halbach-type magnetic pole is a ring-like magnet that is composed of multiple sub-magnetic areas 12 comprising permanent magnets of rotating patterns. It is noted that it is unable to induce plasma using a low-wattage microwave discharge in the magnetic field produced by the aforesaid Halbach-type magnetic pole under a low pressure environment of 9×10⁻⁵ torr.

In a conventional technique disclosed in WO99/39860, the effectiveness of electron cyclotron resonance is improved not only by the use of a comparatively larger permanent magnet, but also by adding a soft iron with high permeability to assist the permanent magnet for generating a wide and more evenly distributed magnetic field. Moreover, in U.S. Pat. No. 4,778,561, an electron cyclotron resonance (ECR) plasma source is disclosed, in which the uniformity of the plasma formed in a plasma generating chamber is enhanced by the use of two magnetic field sources. In U.S. Pat. No. 5,370,765, another electron cyclotron resonance (ECR) plasma generating apparatus is disclosed, in which the formation of high plasma density is achieved by arranging magnetic field forming magnets circumferentially about the plasma generating chamber for forming continuous, axisymmetric field force lines annularly extending about the chamber and for producing a resonant interaction envelope within the chamber, and thus reducing plasma losses to chamber walls. In addition, in U.S. Pat. No. 4,987,346, a particle source for generating a plasma beam, an ion beam, an electron beam or a neutral particle beam with high density is disclosed, in which a torus-shaped magnetic field is generated and enhanced with the aid of one electromagnets and two permanent magnets that are surrounded by an externally mounted iron yoke.

### TECHNICAL SUMMARY

The present disclosure provides a magnetic module for electron cyclotron resonance (ECR) and ECR apparatus using the same, in which the magnetic module uses permanent magnets as its magnetic field source, and a microwave force for producing an electric field, that are operated in a low pressure environment of 9×10⁻⁵ torr, so as to induce electron cyclotron resonance in a magnetic field of 875 gauss and an electric filed of 2.45 GHz and 70 W. Thereby, the magnetic module is enabled to operate smoothly without the need of any additional current or cooling water as the conventional ECR devices, and also is capable of being used for depositing a film of signal atom layer while consuming less power wattage under low pressure environment.

Moreover, the present disclosure provides a magnetic module for electron cyclotron resonance (ECR) and ECR apparatus using the same, in which the permanent magnets are surrounded by soft irons with high permeability so as to generate a wide and more intensive magnetic field, and thus to enhance the expansibility of the magnetic module and the ECR apparatus as well. In addition, as the magnetic field density in a reaction chamber of the ECR apparatus is enhanced by the construction of a magnetic field source composed of multiple layers of magnets, the losses to chamber walls due to electron collision can be reduced and thus the plasma density to be induced is increased.

In one embodiment, the present disclosure provides a magnetic module for electron cyclotron resonance, which comprises: a plurality of layers of supporting rings, each having an outer surface and an inner surface while having a plurality of through holes radially disposed therein; and a plurality of magnetic pillars, respectively embedded into the plural through holes of the supporting rings while enabling the magnetic fields resulting from the magnetic pillars in any two adjacent supporting rings to be opposite to each other.

In another embodiment, the present disclosure provides an electron cyclotron resonance (ECR) apparatus, which comprises: a chamber; a wave guide module, coupled to the chamber; a quartz shield, disposed inside the chamber; a magnetic module, disposed surrounding outside of the chamber, further comprising a plurality of layers of supporting rings and a plurality of magnetic pillars in a manner that each of the supporting rings, being configured with an outer surface and an inner surface, has a plurality of through holes radially disposed therein, and the plural pillars are disposed respectively embedded into the plural through holes of the supporting rings while enabling the magnetic fields resulting from the magnetic pillars in any two adjacent supporting rings to be opposite to each other; and a platform, disposed inside the chamber.

In further another embodiment, the electron cyclotron resonance (ECR) apparatus further comprises: a magnetic guiding sleeve, disposed surrounding the plural layers of supporting rings while ensheathing the same.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic diagram showing a conventional Halbach-type magnetic pole.

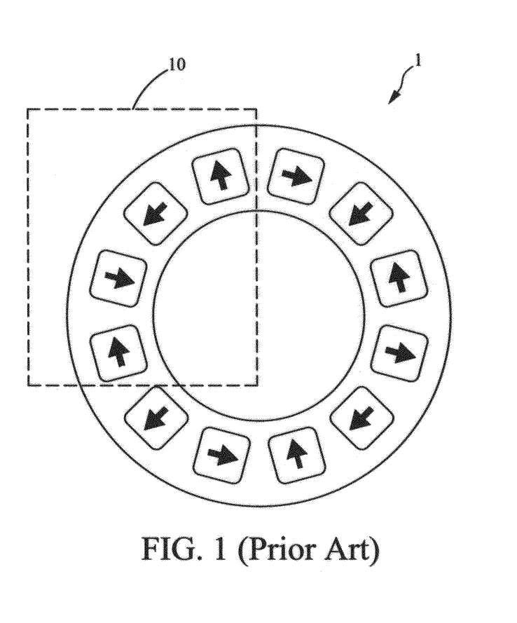

FIG. 2 is a three-dimensional view of a magnetic module for electron cyclotron resonance according to a first embodiment of the present disclosure.

FIG. 3A to FIG. 3D schematic diagrams shown various cross sections of different magnetic pillars used in the present disclosure.

FIG. 4 is a schematic diagram shown a magnetic field generated from the magnetic module of the first embodiment.

FIG. 5A and FIG. 5B are schematic diagrams showing a magnetic module for electron cyclotron resonance according to a second embodiment of the present disclosure.

FIG. 6 is a schematic diagram shown a magnetic field generated from the magnetic module of the second embodiment.

FIG. 7 is a three-dimensional view of a magnetic module for electron cyclotron resonance according to a third embodiment of the present disclosure.

FIG. 8 is a schematic diagram shown a magnetic field generated from the magnetic module of the third embodiment.

FIG. 9 is a schematic diagram shown an ECR apparatus of the present disclosure.

### DESCRIPTION OF THE EXEMPLARY EMBODIMENTS

For your esteemed members of reviewing committee to further understand and recognize the fulfilled functions and structural characteristics of the disclosure, several exemplary embodiments cooperating with detailed description are presented as the follows.

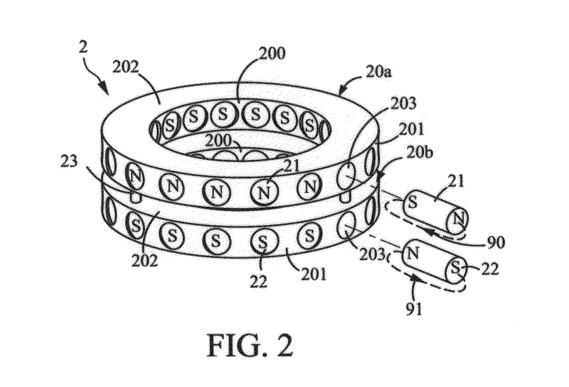

Please refer to FIG. 2, which is a three-dimensional view of a magnetic module for electron cyclotron resonance according to a first embodiment of the present disclosure. In this embodiment, the magnetic module 2 includes two supporting rings 20a, 20b and a plurality of magnetic pillars, as the two magnetic pillars 21, 22 illustrated in FIG. 2, in which the two supporting rings 20a, 20b are coaxially arranged and vertically stacked. Since the two supporting rings 20a, 20b are structurally the same, the following description only addresses the supporting ring 20a as illustration. As shown in FIG. 2, the supporting ring 20a is configured with an inner surface 200 and an outer surface 201 that are connected with each other by two planar surfaces 202, i.e. a top and a bottom, through the edges thereof. In addition, the supporting ring 20a further has a plurality of through holes 203 formed thereon at positions sandwiched between two planar surfaces 202. In this embodiment, each of the plural through holes 203 is formed with two openings arranged respectively on the inner surface 200 and the outer surface 201. It is noted that the through hole 203 is not have to be formed with two openings, it can be opened by one end while being sealed at the other, and the opening end thereof can either be formed on the inner surface 200 or on the outer surface 201. Moreover, there can be a supporting element 23 disposed between the two adjacent supporting rings 20a, 20b for spacing the two away from each other by a specific distance. In this embodiment, the support element 23 is a structure composed of a plurality of supporting columns, but support element 23 can be constructed differently according to actual requirement and thus is not limited thereby.

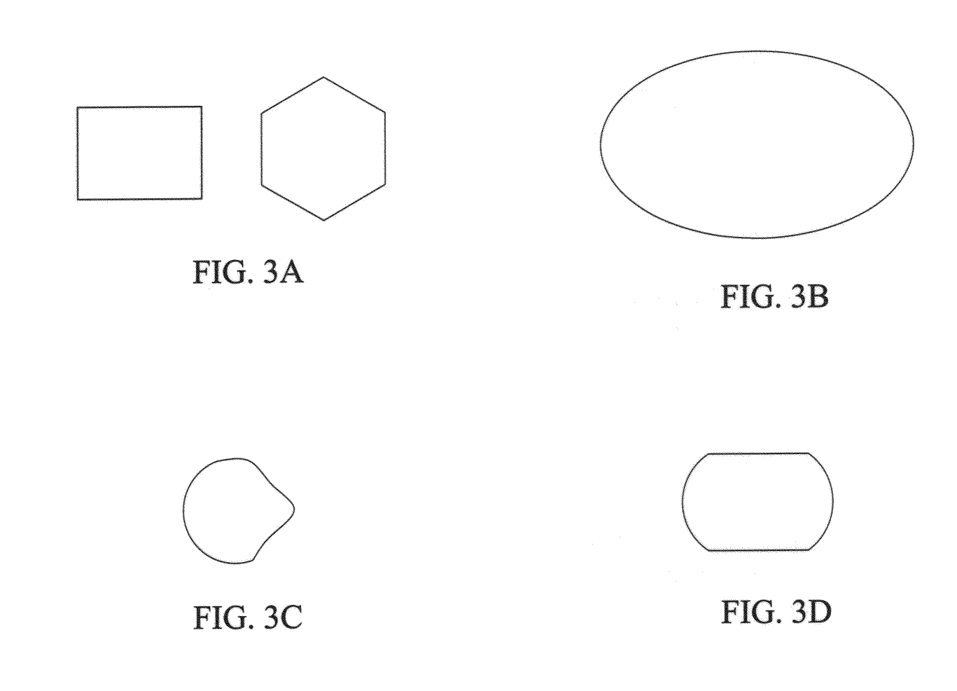

Each of the plural magnetic pillars is capable of inducing a magnetic field that is defined by a magnetic direction. As shown in FIG. 2, the magnetic pillar 21 is defined by the magnetic direction 90 and magnetic pillar 22 is defined by the magnetic direction 92. Moreover, the plural magnetic pillars 21, 22 are being respectively embedded into the plural through holes 203 of the supporting rings 20a, 20b. In FIG. 2, the magnetic pillar 21 is embedded in a through hole 203 formed on the supporting ring 20a while the magnetic pillar 22 is embedded in a through hole 203 formed on the supporting ring 20b, and accordingly that for those other magnetic pillars embedded on the supporting ring 20a, they will be arranged for enabling their magnetic directions to be the same as the magnetic direction 90 of the magnetic pillar 21, and similarly, for those other magnetic pillars embedded on the supporting ring 20b, they will be arranged for enabling their magnetic directions to be the same as the magnetic direction 91 of the magnetic pillar 22. Thereby, the magnetic directions of the magnetic pillars 21 on the supporting ring 20a are opposite to those of the magnetic pillars 22 on the supporting ring 20b. It is noted that in order to enabling the magnetic pillars 21 on the supporting ring 20a to induce magnetic fields of the same magnetic direction 90, the magnetic pillars 21 should be arranged for enabling their polarity on the inner surface 200 and the outer surface 201 to be the same. That is, the magnetic pillars 21 are arranged for enabling their N-poles to be arranged on the outer surface 201 of the supporting ring 20a, and the magnetic pillars 22 are arranged for enabling their S-poles to be arranged on the outer surface 201 of the supporting ring 20b, as shown in FIG. 2. It is also feasible for arranging the S-poles of the magnetic pillars 21 on the outer surface 201 of the supporting ring 20a, and arranging the N-poles of the magnetic pillars 22 on the outer surface 201 of the supporting ring 20b. In this embodiment, each of the plural magnetic pillars 21, 22 is a permanent magnet that can be a Nd—Fe—B magnet, but is not limited thereby. In addition, the outer diameters of the supporting rings 20a, 20b are 15 cm, and the cross section of each magnetic pillars 21, 22 is a circle with 2 cm in diameter, and each magnetic pillars 21, 22 is 3 cm in length. It is noted that the cross sections of each magnetic pillars 21, 22 is not necessary to be formed as a circle, it can be formed in a shape selected from the group consisting of: a circle, an ellipse, a polygon, a curved profile, a profile composed of curved lines and straight lines, as those shown in FIG. 3A to FIG. 3D.

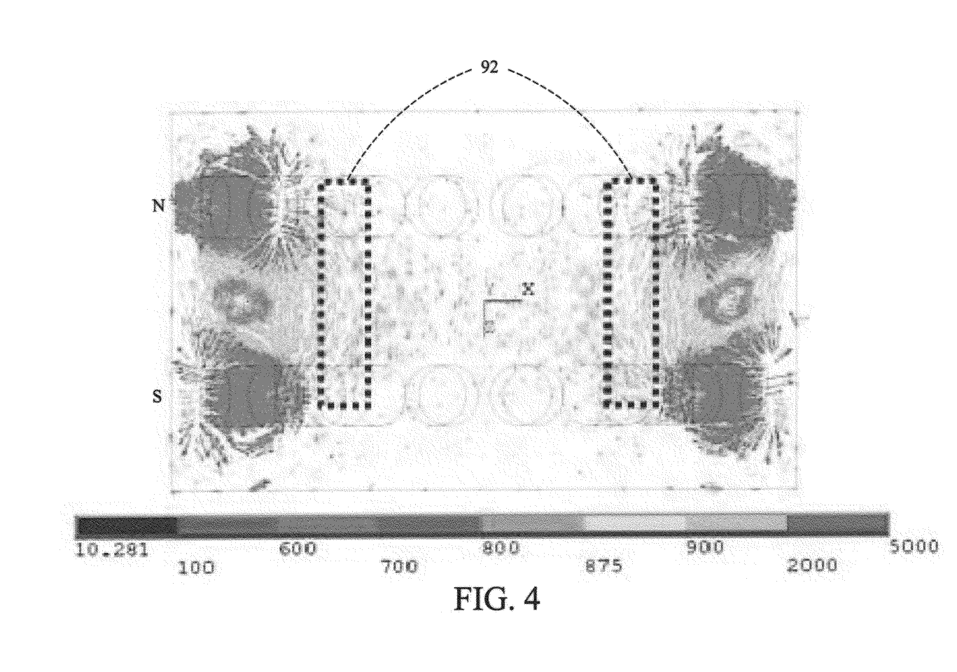

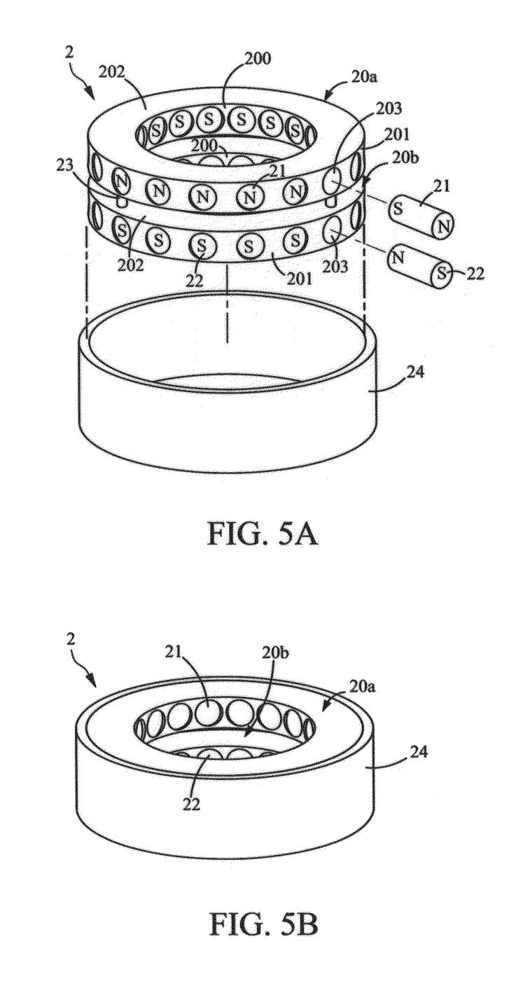

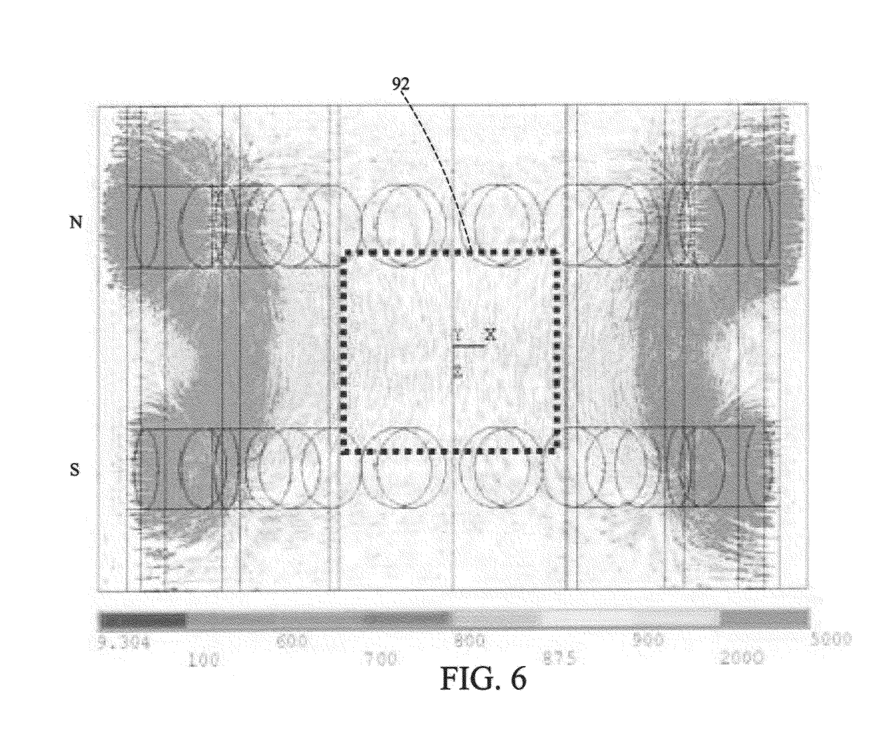

Please refer to FIG. 4, which is a schematic diagram shown a magnetic field generated from the magnetic module of the first embodiment. In FIG. 4, the magnetic field is induced by the magnetic module 2 described in the first embodiment, i.e. the outer diameters of the supporting rings 20a, 20b are 15 cm, and the cross section of each magnetic pillars 21, 22 is a circle with 2 cm in diameter, and each magnetic pillars 21, 22 is 3 cm in length while being magnetized to 5000 gauss so as to induce a magnetic field as high as 875 gauss, as the areas 92 shown in FIG. 4. Please refer to FIG. 5A and FIG. 5B, which are schematic diagrams showing a magnetic module for electron cyclotron resonance according to a second embodiment of the present disclosure. In this embodiment, the intensity and the uniformity of the magnetic field being induced by the magnetic module are enhanced comparing with the one shown in the first embodiment. For achieving that, there is a magnetic guiding sleeve 24 being disposed surrounding the outer surfaces 201 of the two layers of supporting rings 20a, 20b while ensheathing the same. It is noted that the magnetic guiding sleeve 24 can be made of a silicon steel or a soft iron, but is not limited thereby. In this embodiment, the magnetic guiding sleeve 24 is made of a soft iron. Please refer to FIG. 6, which is a schematic diagram shown a magnetic field generated from the magnetic module of the second embodiment. By surrounding the two stacking supporting rings 20a, 20b with a magnetic guiding sleeve 24 made of soft iron, not only the two supporting rings 20a, 20b can be enabled to induce magnetic fields of high intensity, but also the structure is able to enhance the recoil of electrons and thus increase the lifetime of the electrons. In this embodiment, the outer diameters of the supporting rings 20a, 20b are 15 cm, and the cross section of each magnetic pillars 21, 22 is a circle with 2 cm in diameter, and each magnetic pillars 21, 22 is 3 cm in length while being magnetized to 5000 gauss so as to induce a magnetic field as high as 875 gauss, as the areas 93 shown in FIG. 6 which is a significant increment in area comparing to the area 92 shown in FIG. 4.

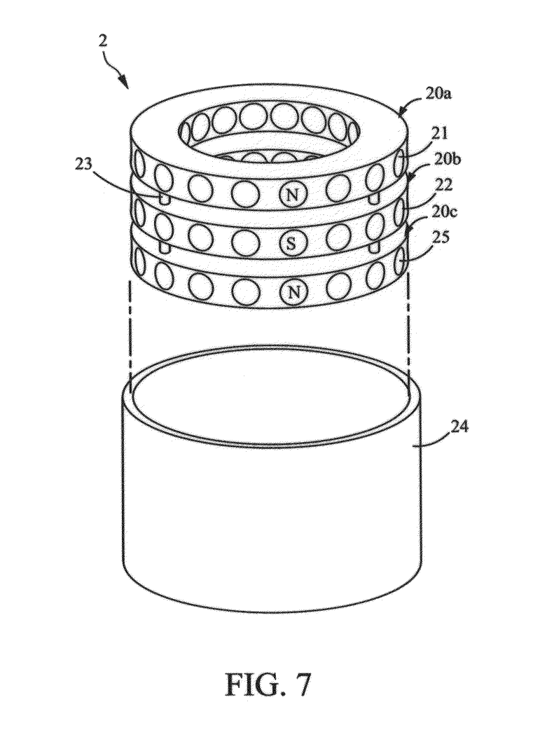

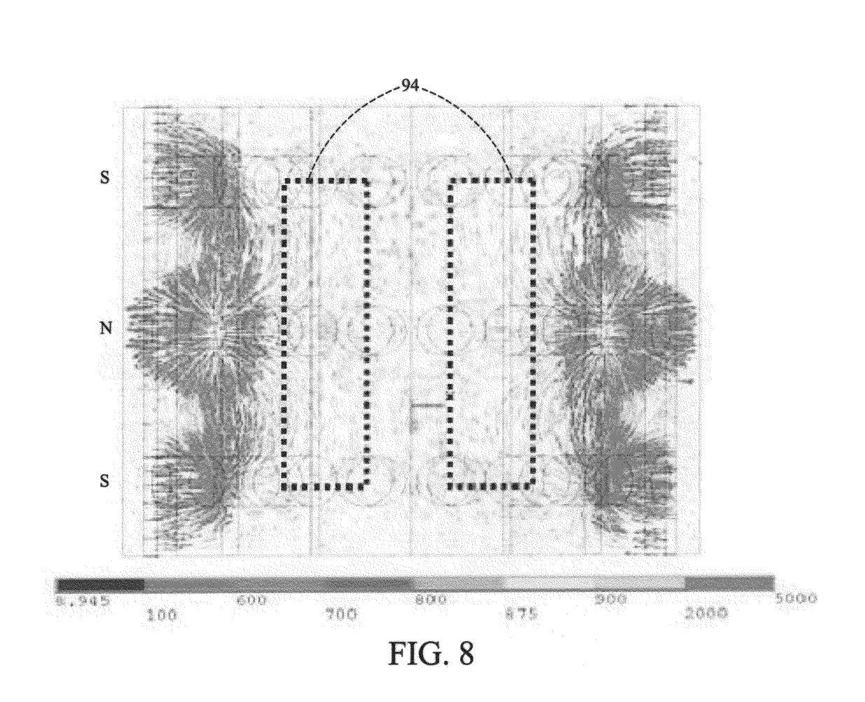

Except for the two-layered structures of supporting rings that are shown in the foregoing embodiments, the magnetic module of the present disclosure can be constructed as a three-layered structure, as the third embodiment shown in FIG. 7. In this embodiment, there are three supporting rings 20a, 20b, 20c that are coaxially arranged and vertically stacked while being spaced from each other by the use of support elements 23. In addition, each of the supporting rings 20a, 20b, 20c is configured with a plurality of magnetic pillars, as the magnetic pillars 21 on the supporting ring 20a, the magnetic pillars 22 on the supporting ring 20b and the magnetic pillars 25 on the supporting ring 20c. It is noted that each of the magnetic pillars 21, 22, 25 are capable of inducing a magnetic field, and the magnetic directions of the magnetic fields resulting from the magnetic pillars in any two adjacent supporting rings, i.e. the supporting rings 20a and 20b or supporting rings 20b and 20c, are to be opposite to each other. Similarly, there is a magnetic guiding sleeve 24 being disposed surrounding the three-layered structure of the supporting rings 20a, 20b, 20c while ensheathing the same, and also the magnetic guiding sleeve 24 can be made of a silicon steel or a soft iron, but is not limited thereby. It is emphasized that there can be a plurality of supporting rings used in the present disclosure, whereas the amount of the layers of supporting rings is an even number or an odd number. Please refer to FIG. 8, which is a schematic diagram shown a magnetic field generated from the magnetic module of the third embodiment. Similarly, the recoil of electrons and thus increase the lifetime of the electrons. In this embodiment, the outer diameters of the supporting rings 20a, 20b, 20c are 15 cm, and the cross section of each magnetic pillars 21, 22, 25 is a circle with 2 cm in diameter, and each magnetic pillars 21, 22, 25 is 3 cm in length while being magnetized to 5000 gauss so as to induce a magnetic field as high as 875 gauss, thereby, not only the two supporting rings 20a, 20b can be enabled to induce magnetic fields of high intensity, but also the structure is able to enhance the recoil of electrons and thus increase the lifetime of the electrons. In addition, the area enclosed by the inner surfaces 200, such as the areas 94 shown in FIG. 8, the intensity of the magnetic fields is 875 gauss.

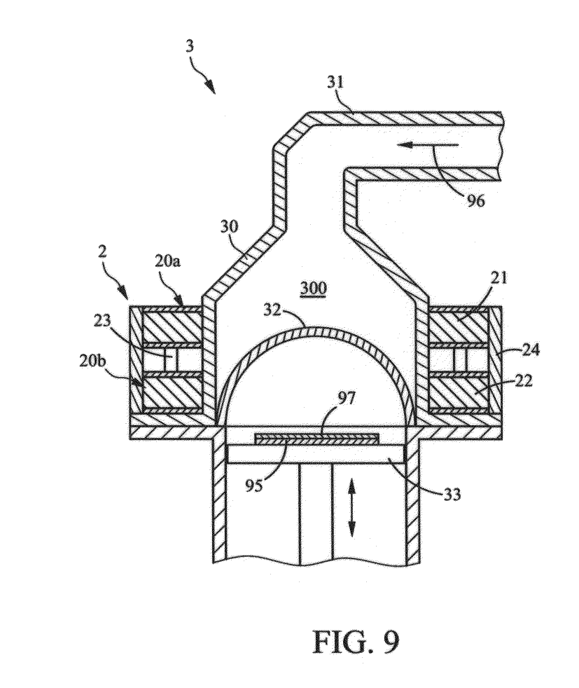

Please refer to FIG. 9, which is a schematic diagram shown an ECR apparatus of the present disclosure. The ECR apparatus shown in this embodiment is an ECR apparatus of transverse electric field. As shown in FIG. 9, the ECR apparatus comprises: a chamber 30, a wave guide module 31, a quartz shield 32, a magnetic module 2 and a platform 33. The chamber 30 is formed with an accommodation space 300; the wave guide module 31 is coupled to the chamber 30 to be used for guiding microwaves 96 into the chamber 30. It is noted that the wave guide module 31 used in this embodiment is a wave guide module with transverse electric field, but it is not limited thereby that it can be a wave guide module with transverse magnetic field. Moreover, the frequency of the microwaves being transmitted and guided by the wave guide module 31 is 2.45 GHz and the power thereof is higher than 1 watt. In addition, the quartz shield 32 is disposed inside the chamber 30; and the magnetic module 2 is disposed surrounding the circumference of the chamber 30. It is noted that the magnetic field 2 used in this embodiment can be the one illustrated in FIG. 2, FIG. 5A or FIG. 7, and thus will not be described further herein. The platform 33 is disposed inside the chamber 30 to be used for supporting a substrate 95, by that the position of the substrate 95 can be adjusted as the platform 33 is being driven to move vertically up and down inside the chamber 30.

By the aforesaid magnetic module 2, a comparative wide effective area of electron cyclotron resonance can be formed inside the chamber at the atmosphere pressure of higher than 5×10⁻⁵ torr. In this embodiment, the ECR apparatus is configured to induce high density plasma using a microwave of a specific power and 2.45 GHz in frequency for depositing a film of single atom layer on the substrate 97. In this embodiment, the film of single atom layer is made of graphene, but is not limited thereby. In addition, each of the magnets used in the magnetic module 2 is the composition of many small magnets, so that it can be expand easily. To sum up, the ECR apparatus is able to operate smoothly without the need of any additional current or cooling water as the conventional ECR devices, and also is capable of being used for depositing a film of signal atom layer while consuming less power wattage under low pressure environment. In addition, as the magnetic field density in a reaction chamber of the ECR apparatus is enhanced by the construction of a magnetic field source composed of multiple layers of magnets, the losses to chamber walls due to electron collision can be reduced and thus the plasma density to be induced is increased, so that no addition external electromagnet is needed for generating electric filed so as to constrain electrons, and thereby, the manufacturing cost is reduced.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A magnetic module for electron cyclotron resonance, comprising:
a plurality of layers of supporting rings, each configured with an outer surface and an inner surface and having a plurality of through holes radially disposed therein; and
a plurality of magnetic pillars, respectively embedded into the plural through holes of the supporting rings while enabling the magnetic fields resulting from the magnetic pillars in any two adjacent supporting rings to be opposite to each other.

2. The magnetic module of claim 1, wherein there is a magnetic guiding sleeve being disposed surrounding the circumference of the plural layers of supporting rings.

3. The magnetic module of claim 2, wherein the magnetic guiding sleeve is made of a material selected from the group consisting of: a silicon steel and a soft iron.

4. The magnetic module of claim 2, being configured for generating a magnetic field of at least 875 gauss.

5. The magnetic module of claim 1, wherein the amount of the layers of supporting rings is an even number.

6. The magnetic module of claim 1, wherein the amount of the layers of supporting rings is an odd number.

7. The magnetic module of claim 1, wherein each of the plural through holes is formed penetrating from the outer surface to the inner surface of its corresponding supporting ring.

8. The magnetic module of claim 1, wherein there is a supporting element disposed between any two adjacent supporting rings for spacing the two away from each other by a specific distance.

9. The magnetic module of claim 1, wherein the cross section of each of the plural magnetic pillars is formed in a shape selected from the group consisting of: a circle, an ellipse, a polygon, a curved profile, a profile composed of curved lines and straight lines.

10. The magnetic module of claim 1, wherein the magnetic fields of the magnetic pillars that are embedded in the through holes of the same supporting ring are aligned in the same direction.

11. The magnetic module of claim 1, wherein the outer diameter of each supporting ring is 15 cm; and each magnetic pillar is 3 cm in height and 2 cm in diameter while being magnetized to 5000 gauss.

12. An electron cyclotron resonance (ECR) apparatus, comprising:
a chamber;
a wave guide module, coupled to the chamber;
a quartz shield, disposed inside the chamber;
a magnetic module, disposed surrounding outside of the chamber, further comprising a plurality of layers of supporting rings and a plurality of magnetic pillars in a manner that each of the supporting rings, being configured with an outer surface and an inner surface, has a plurality of through holes radially disposed therein, and the plural pillars are disposed respectively embedded into the plural through holes of the supporting rings while enabling the magnetic fields resulting from the magnetic pillars in any two adjacent supporting rings to be opposite to each other; and
a platform, disposed inside the chamber.

13. The ECR apparatus of claim 12, wherein there is a magnetic guiding sleeve being disposed surrounding the circumference of the plural layers of supporting rings.

14. The ECR apparatus of claim 13, wherein the magnetic guiding sleeve is made of a material selected from the group consisting of: a silicon steel and a soft iron.

15. The ECR apparatus of claim 13, wherein the magnetic module is configured for generating a magnetic field of at least 875 gauss.

16. The ECR apparatus of claim 12, being an ECR apparatus of transverse electric field.

17. The ECR apparatus of claim 12, wherein being an ECR apparatus of transverse magnetic field.

18. The ECR apparatus of claim 12, being configured to induce plasma using a microwave of a specific power for depositing a large-area film on a substrate that is disposed on the platform under an environment whose atmosphere pressure is larger than 5×10⁻⁵ torr.

19. The ECR apparatus of claim 18, wherein the large-area film is made of graphene.

20. The ECR apparatus of claim 12, wherein the amount of the layers of supporting rings is an even number.

21. The ECR apparatus of claim 12, wherein the amount of the layers of supporting rings is an odd number.

22. The ECR apparatus of claim 12, wherein each of the plural through holes is formed penetrating from the outer surface to the inner surface of its corresponding supporting ring.

23. The ECR apparatus of claim 12, wherein there is a supporting element disposed between any two adjacent supporting rings for spacing the two away from each other by a specific distance.

24. The ECR apparatus of claim 12, wherein the cross section of each of the plural magnetic pillars is formed in a shape selected from the group consisting of: a circle, an ellipse, a polygon, a curved profile, a profile composed of curved lines and straight lines.

25. The ECR apparatus of claim 12, wherein the magnetic fields of the magnetic pillars that are embedded in the through holes of the same supporting ring are aligned in the same direction.

26. The ECR apparatus of claim 12, wherein the outer diameter of each supporting ring is 15 cm; and each magnetic pillar is 3 cm in height and 2 cm in diameter while being magnetized to 5000 gauss.
